(19) United States
(12) Patent Application Publication
(10) Pub. No.: US 2009/0283613 A1
(43) Pub. Date: Nov. 19, 2009

(54) Foam silicone parts in irrigation emitters

(76) Inventor: Tzvi Barkai, D.N.Hanegev (IL)

Correspondence Address: THE NATH LAW GROUP, 112 South West Street, Alexandria, VA, 22314, US

(21) Appl. No.: 11/990,507

(22) PCT Filed: Aug. 9, 2006
(86) PCT No.: PCT/IL2006/000918

§ 371 Date: Feb. 15, 2008

Related U.S. Application Data
(60) Provisional application No. 60/708,790, filed on Aug. 17, 2005.

(51) Int. Cl. B05B 1/30; B29C 44/02; B29D 31/00; F16K 31/126

(52) U.S. Cl. 239/542; 264/51; 264/50; 264/41; 137/510; 29/890.124; 29/722

(57) ABSTRACT

An elastic membrane is provided for use in a flow-control device comprising a housing with a seat of a predetermined shape and dimensions for the membrane such that when the membrane is mounted in the seat, the membrane is deflected by a pressure differential between its two opposite sides. The elastic membrane has a predetermined shape and dimensions matching the seat and is made of foamed elastomer with closed cells of predetermined cell density and morphology.

### FIELD OF THE INVENTION

This invention relates to production of elastic membranes for irrigation emitters, in particular from foamed elastomers.

### BACKGROUND OF THE INVENTION

A typical pressure-compensated or pressure-regulated irrigation emitter, for example described in U.S. Pat. No. 6,206,305, comprises a housing with an inlet connected to a pressurized irrigation water source and an outlet connected to the atmosphere. A flow-restricting path is formed in the housing between the inlet and the outlet, the flow-restricting path having considerable hydraulic resistance. The housing is assembled from two halves with a flat elastic membrane interposed between them such that one side of the membrane is exposed to the inlet pressure of the irrigation water while the other side is opposite the outlet and is exposed to reduced flow pressure after the flow-restricting path. In operation, the membrane is deflected by the pressure differential towards the outlet and further restricts the flow. The higher the inlet pressure, the more the outlet flow is restricted. Thus, pressure variations of the irrigation water source may be compensated, keeping a relatively constant flow rate at the emitter outlet.

The membranes for such emitters are typically made from elastomers such as EPDM, NR, or silicone rubber, or thermoplastic elastomers such as TPV, or TPO, or SEBS. The compensated flow rate of the emitter depends on the elastic properties of the membrane material. The elastic modulus of the material has critical effect on the elastic behavior of the membrane which further depends on its thickness, shape and way of fixation in the housing.

The elastic properties of elastomers are affected by the material grade (elastomer type and grade), the compound composition (additives and their addition level), and state of cure. The processing conditions, such as temperature and cycle time affect mainly the state of cure. Therefore, rubber membranes have variations in their elastic properties. If the membrane material changes its elastic properties, then the design flow rate of the compensated emitter can be maintained only by changing the membrane thickness and the geometry of the emitter polymer parts. This is very expensive, and necessitates keeping stock of membranes with different properties.

### SUMMARY OF THE INVENTION

Technology of elastomers allows production of expanded elastomers by foaming them with gas. The gas can be introduced to the elastomer in the molten state by direct injection of gas such as CO₂, N₂, or gas-forming material such as water or pentane. The gas can also be introduced to the melt by inclusion of chemical blowing agents that decompose and release gas at processing temperatures. Under controlled conditions, closed cells will be formed. The cell density and morphology will have dominant effect on the elastic properties of the foamed elastomer. Application of foaming will enable the variation of the elastic properties of a single compound without need to change composition or elastomer grade. This feature has dramatic benefit to the process as it allows immediate modification of the elastic properties of emitter membranes.

In accordance with the present invention, there is provided an elastic membrane for use in a flow-control device comprising a housing with a seat of a predetermined shape and dimensions for the membrane such that when the membrane is mounted in the seat, the membrane is deflected by a pressure differential between its two opposite sides. The elastic membrane has a predetermined shape and dimensions matching the seat and is made of foamed elastomer with closed cells of predetermined cell density and morphology.

The flow-control device may be of the kind used in irrigation, for example a pressure-regulated irrigation emitter. The emitter comprises a housing with an inlet connectable to a pressurized irrigation water source, an outlet connectable to a low-pressure sink, a flow-restricting path between the inlet and the outlet, such that when the membrane is mounted in the seat, its one side is exposed to the inlet pressure while its other side is opposite the outlet and is exposed to the flow pressure after the flow-restricting path. Thus, in operation, the membrane is deflected towards the outlet and further restricts the flow through the emitter.

Advantageously, a series of such elastic membranes, each having identical shape and dimensions, may be made of the same elastomer, such that at least two of the elastic membranes have different elastic properties due to different foam density and/or morphology. Alternatively, series of elastic membranes, each having identical shape and dimensions, may be made of elastomer with varying composition and different foam density and/or morphology, such that the elastic properties of the membranes are identical or within predetermined range.

According to another aspect of the present invention, there are provided methods for production of the series of elastic membranes. The methods include production of the elastic membranes by injection molding and foaming of elastomer in molds of identical shape and dimensions, or continuous molding of the foamed elastomer, or extrusion of the foamed elastomer. In each method, the elastic properties are varied by varying cell density and morphology of the foamed elastomer, for example by varying the process conditions such as temperatures, pressures, rate of gas input or proportion of gas-forming agent. Alternatively, the elastic properties of the membranes in a series may be kept identical or within a predetermined range while the membranes are made of elastomer with varying composition, by varying the foam density and/or morphology of each membrane.

According to a further aspect of the present invention, there is provided a flow-control device, such as a pressure-regulated irrigation emitter, using the above-described elastic membrane with a predetermined shape and dimensions matching the seat in the emitter and made of foamed elastomer with closed cells of predetermined cell density and/or morphology. The devices can be provided in series, each device having an elastic membrane of identical shape and dimensions, made of the same elastomer composition, and at least two of the elastic membranes having different elastic properties due to different cell density and/or morphology. Alternatively, series of devices may be provided, with elastic membranes, each having identical shape and dimensions, made of elastomer with varying composition and different foam density and/or morphology, such that the elastic properties of the membranes are identical or within predetermined range.

According to yet another aspect of the present invention, there is provided a method for production of a plurality of flow-control devices comprising elastic membranes with identical shape and dimensions made of the same material, the devices having flow-control parameters depending on the elastic properties of the membranes, and the method including
providing components for the plurality of flow-control devices, other than the elastic membranes;
providing a plurality of the elastic membranes; and
assembly of the plurality of flow-control devices from the components and the elastic membranes on a conveyor line;

wherein the plurality of elastic membranes have varying elastic properties.

The plurality of elastic membranes may be produced by foaming an elastomer to form closed-cell foam, and varying the cell density and morphology, by varying the process conditions such as temperatures, pressures, gas supply rate, etc. in the process of injection molding or continuous molding, or extrusion.

According to yet another aspect of the present invention, there is provided a facility for production of a plurality of flow-control devices comprising elastic membranes with identical shape and dimensions made of the same material, the devices having control parameters depending on the elastic properties of the membranes.

The expanded membranes of the present invention offer a number of advantages:
economy of material (elastomer) per produced dripping unit;
economy of molds for dripping units of various flow parameters;
simple regulation of the flow-control parameters of the drippers in mass production;
operative compensation of variations in the raw elastomer properties (chemical composition, etc.) during injection molding or curing.

### BRIEF DESCRIPTION OF THE DRAWINGS

In order to understand the invention and to see how it may be carried out in practice, an embodiment will now be described, by way of non-limiting example only, with reference to the accompanying drawings, in which:

FIG. 1 is a sectional elevation of a pressure-compensated dripping emitter using a membrane in accordance with the present invention;

FIG. 2 is a top view of the dripping emitter in FIG. 1;

FIG. 3 is a side view of a rotary sprinkler using another membrane in accordance with the present invention; and

FIG. 4 is a flowchart of the process whereby the elastic properties of a foamed membrane are controlled during manufacture by the method of the present invention.

### DETAILED DESCRIPTION OF EXEMPLARY EMBODIMENTS

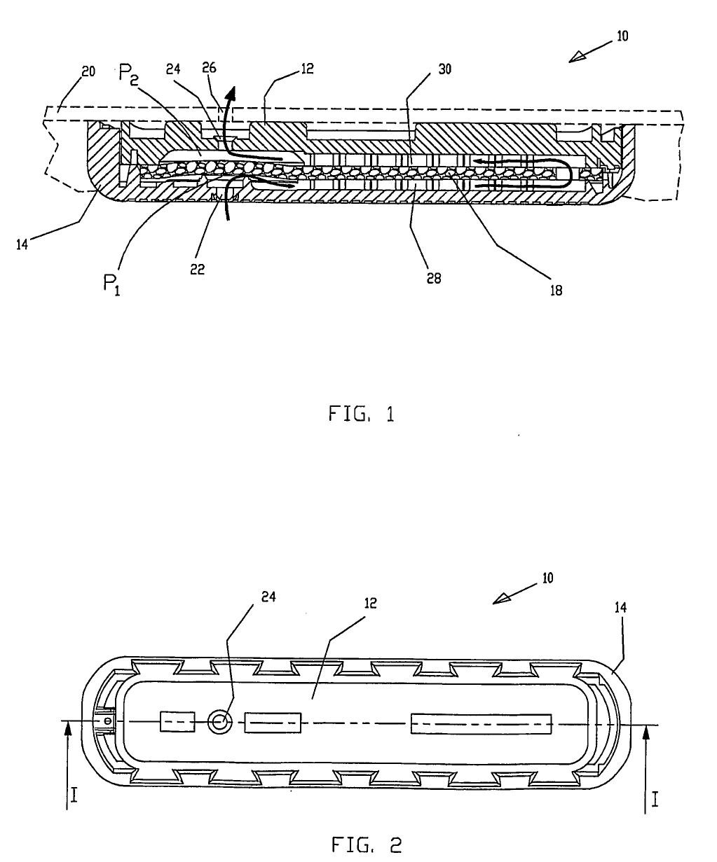

With reference to FIGS. 1 and 2, there is shown an exemplary pressure-compensated irrigation emitter 10, comprising a housing assembled from an upper half 12 and lower half 14, with a flat elastic membrane 18 snapped between the halves. The emitter is welded to the inner wall of an irrigation pipe 20.

The emitter has an inlet 22 facing the pipe interior and an outlet 24 connected to the atmosphere through an orifice 26 in the pipe 20. A flow-restricting labyrinth 28-30 is formed in the housing between the inlet and the outlet.

In operation, one side of the membrane 18 is exposed to the pressure P₁ of the irrigation water in the pipe while the other side opposite the outlet 24 is exposed to reduced flow pressure P₂ after the flow-restricting labyrinth. The membrane is deflected by the pressure differential ΔP=P₁-P₂ towards the outlet 24 to further restrict the flow. The membrane deflection thus affects the outlet flow rate.

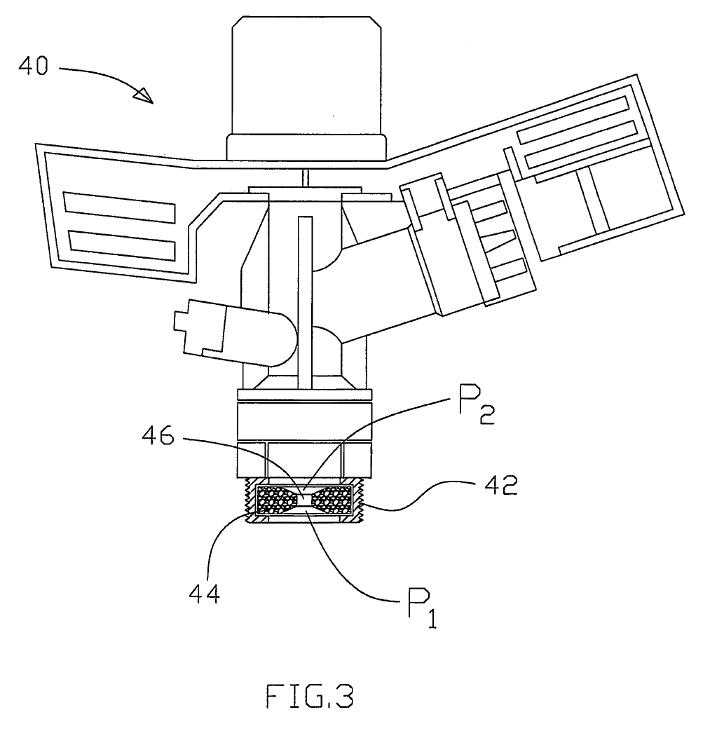

Another example is shown in FIG. 3 illustrating a rotary sprinkler 40 having an inlet fitting 42 with an elastic membrane 44. The membrane has a regulating orifice 46. The membrane 44 is deflected by the pressure differential between the entry side and the exit side ΔP=P₁-P₂.

It will be appreciated that, for a given pressure differential ΔP, the membrane deflection will generally depend on the elastic properties of the membrane material, membrane thickness and the fixation of the membrane periphery (snapping). The membrane thickness and shape in general, as well as the snapping, are predetermined by the emitter design. The membrane must fit in the seat provided between the halves 12 and 14 after they are snapped together. In the particular example of FIG. 1, a thinner membrane would leak water about its edges or about the labyrinth edges, while a thicker membrane would not allow proper snapping and proper welding of both halves to the pipe wall. Thus, it would seem that if a change of the flow rate is desirable, a membrane of different shape (thickness) should be used—involving a change of the emitter design to accommodate the new membrane, —or the membrane elastomer material (composition or grade) should be changed.

However, according to the present invention, the membrane 18 may be made in a novel way. Technology of elastomers allows production of expanded elastomers by foaming them with gas. The gas can be introduced in the elastomer in the molten state by direct injection of gas such as CO₂, N₂, or gas-forming agent such as water or pentane. The gas can also be introduced to the melt by inclusion of chemical blowing agents that decompose and release gas at processing temperatures. Under controlled conditions, closed cells will be formed. The cell density and morphology will have dominant effect on the elastic properties of the foamed elastomer.

For example, Silastic® sponge of Dow Corning may be produced with varying specific gravity, i.e., varying density of the bubbles. This is achieved by variation of curing/sponging temperature. This is possible since the addition cure system used in this new technology sponge is capable of curing the rubber over a range of temperatures. Thus, the compression-deflection (elasticity) of the sponge can also be varied with process temperature adjustment.

According to the present invention, application of foaming in the membrane manufacture will enable the variation of the elastic properties of a single compound without need to change composition or elastomer grade. This feature has dramatic benefit to the process as it allows immediate modification of the elastic properties of the emitter membranes.

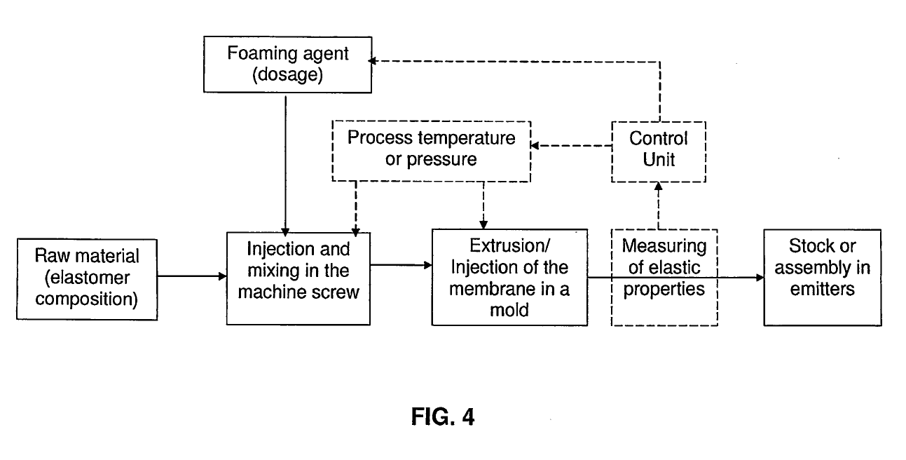

The process of membrane production is illustrated schematically by a flow chart shown in FIG. 4 where control operations and data flow are shown in dashed lines:
Raw material (elastomer composition) is fed to an injection machine screw chamber;
Foaming agent is supplied by a dosing dispenser to the same chamber for mixing with the elastomer composition;
The mixture is extruded/injected in a mold for the membrane;
Ready membranes are transported to stock or directly for assembly in drip emitters.

During the membrane production, the process may be controlled for example in the following way:
Elastic properties of the membranes are measured;
Measured data is assessed by a computerized control unit;
Process conditions such as temperature and pressure, or dosage of the foaming agent, are changed operatively for obtaining desired elastic properties.

The method of the present invention may be used in production of the elastic membranes by injection molding and foaming of elastomer in molds of identical shape and dimensions, or continuous molding of the foamed elastomer, or extrusion of the foamed elastomer. In each method, the elastic properties are varied by varying cell density and morphology of the foamed elastomer, for example by varying the process conditions such as temperatures (of the material or of the mold), pressures (of the input gas, of the injection, counter pressure in the mold, etc), rate of gas input or proportion of gas-forming agent.

The method may include production of a continuous flat sheet and further stamping/cutting of membranes from the sheet.

Series of elastic membranes, each having identical shape and dimensions, may be made of the same elastomer, such that the membranes would have different elastic properties due to different foam density and/or morphology. Accordingly, series of emitters can be assembled, each emitter having an elastic membrane of identical shape and dimensions, made of the same elastomer composition, such that the emitters would have different drip flow rates.

Such series of emitters or indeed a series of any other flow-control devices comprising elastic membranes with identical shape and dimensions made of the same material, the devices having flow-control parameters depending on the elastic properties of the membranes, may be assembled in the following way:
providing components for the series of flow-control devices, other than the elastic membranes;
providing a series of the elastic membranes with varying elastic properties; and
assembly of the series of flow-control devices from the components and the elastic membranes on a conveyor line.

A series of such emitters may be incorporated during production in one branch (pipe) of an irrigation system such that each emitter will open at slightly different pressure, i.e., not simultaneously, to avoid occurrence of water hammer.

The method of the present invention allows also to solve an inverse problem—a series of elastic membranes, each having identical shape and dimensions, may be made of elastomer with varying composition and different foam density and/or morphology, such that the elastic properties of the membranes are identical or within predetermined range. In other words, deviations of the elastomer composition bearing on the membrane elasticity may be operatively compensated without changing the membrane shape.

1-24. (canceled)

25. An elastic membrane for use in a flow-control device, said device comprising a housing with a seat of a predetermined shape and dimensions for said membrane such that when said membrane is mounted in said seat and is in operation, said membrane is deflected by a pressure differential between its two opposite sides, wherein said elastic membrane has a predetermined shape and dimensions matching said seat and is made of foamed elastomer with closed cells of predetermined cell density and morphology.

26. A series of elastic membranes, each membrane according to claim 25, each membrane of the series having identical shape and dimensions, and being made of the same elastomer, wherein at least two of the elastic membranes have different elastic properties due to different cell density and/or morphology.

27. A series of elastic membranes, each membrane according to claim 25, each having identical shape and dimensions, and being made of elastomer with varying composition, wherein the membranes of said series have varying foam density and/or morphology, such that elastic properties of the membranes are within a predetermined range.

28. The elastic membrane of claim 25 for use in a pressure-regulated irrigation emitter, said housing comprising an inlet connectable to a pressurized irrigation water source, an outlet connectable to a low-pressure sink, a flow-restricting path between the inlet and the outlet, such that when said membrane is mounted in said seat its one side is exposed to the inlet pressure while its other side is opposite to said outlet and is exposed to the flow pressure after said flow-restricting path, so that in operation, said membrane is deflected towards said outlet and further restricts the flow through said emitter.

29. A method for production of a series of elastic membranes for use in a flow-control device, said method including production of said elastic membranes by any process including forming the membranes in molds of identical shape and dimensions and foaming the elastomer, or forming of a continuous sheet of foamed elastomer, wherein during said production of the elastic membranes, their elastic properties are controlled by varying cell density and/or morphology of the foamed elastomer.

30. The method of claim 29, wherein the composition of said elastomer is the same for each membrane, and said elastic properties of the membranes are varied by varying cell density and/or morphology of the foamed elastomer.

31. The method of claim 29, wherein the composition of said elastomer varies during the production of said series, but said elastic properties of the membranes are kept within a predetermined range by varying cell density and/or morphology of the foamed elastomer.

32. The method of claim 29, wherein said process is one of the following: injection molding, or continuous molding, or extrusion.

33. The method of claim 29, wherein said process includes extrusion of a continuous sheet of foamed elastomer with constant thickness and cutting said elastic membranes from said sheet.

34. The method of claim 29, wherein said controlling of the cell density or morphology of the foamed elastomer is performed by varying one or more of the following process conditions: temperature, pressure, rate of gas input or proportion of gas-forming agent.

35. A flow-control device comprising a housing with an elastic membrane disposed in a seat of a predetermined shape and dimensions, such that in operation, said membrane is deflected by a pressure differential between its two opposite sides, wherein said elastic membrane has a predetermined shape and dimensions matching said seat and is made of foamed elastomer with closed cells of predetermined density and/or morphology.

36. The device of claim 35, wherein said device is adapted for use in irrigation.

37. The device of claim 35, being a pressure-regulated irrigation emitter, comprising an inlet connectable to a pressurized irrigation water source, an outlet connectable to a low-pressure sink, a flow-restricting path between the inlet and the outlet, such that when said membrane is mounted in said seat its one side is exposed to the inlet pressure while its other side is opposite to said outlet and is exposed to the flow pressure after said flow-restricting path, so that in operation, said membrane is deflected towards said outlet and further restricts the flow through said emitter.

38. A series of irrigation devices, each device according to claim 35, each device of the series having an elastic membrane of identical shape and dimensions, made of the same elastomer, wherein at least two of the elastic membranes have different elastic properties due to different density and/or morphology of the closed cells.

39. A series of irrigation devices, each device according to claim 35, each device of the series having an elastic membrane of identical shape and dimensions, the elastic membranes in said series of devices being made of elastomer with varying composition, wherein elastic properties of said elastic membranes are within a predetermined range due to different density and/or morphology of the closed cells.

40. A method for production of a plurality of flow-control devices, said devices comprising elastic membranes with identical shape and dimensions made of the same material, said devices having control parameters depending on the elastic modulus of said membranes, said method including:
(a) providing components for said plurality of flow-control devices, other than said elastic membranes;
(b) providing a plurality of said elastic membranes; and
(c) assembly of said plurality of flow-control devices from said components and said elastic membranes on a conveyor line;
wherein said plurality of elastic membranes have varying elastic properties.

41. The method of claim 40, wherein said plurality of elastic membranes are produced by any method including forming the membranes in molds of identical shape and dimensions and foaming the elastomer, or forming of a continuous sheet of foamed elastomer, wherein during said production of the elastic membranes, their elastic properties are varied by varying cell density and/or morphology of the foamed elastomer.

42. The method of claim 40, wherein said plurality of elastic membranes are produced by one of the following: injection molding, or continuous molding, or extrusion.

43. The method of claim 40, wherein said plurality of elastic membranes are produced by extrusion of a continuous sheet of foamed elastomer with constant thickness and cutting said elastic membranes from said sheet.

44. The method of claim 41, wherein said varying of the cell density and morphology is performed by varying one or more of the following process conditions: temperature, pressure, rate of gas input or proportion of gas-forming agent.

45. A production facility for production of flow-control devices, said devices comprising elastic membranes with identical shape and dimensions made of the same material, the facility including:
(a) means for supplying components for said flow-control devices, other than said elastic membranes;
(b) means for supplying said elastic membranes in series of varying elastic modulus; and
(c) a conveyor line for assembly of said flow-control devices from said components and said elastic membranes.

46. The facility of claim 45, wherein said means for supplying said elastic membranes include a line for production of an elastomer with closed-cell foam structure.

47. The facility of claim 46, wherein said line for production of an elastomer is adapted for varying the cell density and/or morphology of said elastomer.

48. The facility of claim 47, wherein said line for production of an elastomer is adapted for varying the cell density and/or morphology of said elastomer by varying one or more of the following process conditions: temperature, pressure, rate of gas input or proportion of gas-forming agent.
